(19) United States
(12) Patent Application Publication
(10) Pub. No.: US 2019/0254255 A1
(43) Pub. Date: Aug. 22, 2019

(54) Method and Device for Cooling or Warming Cattle

(71) Applicants: Bethany L. Szijarto, Brunswick, OH (US); Istvan J. Szijarto, Brunswick, OH (US); Leo P. Szijarto, Brunswick, OH (US)

(72) Inventors: Bethany L. Szijarto, Brunswick, OH (US); Istvan J. Szijarto, Brunswick, OH (US); Leo P. Szijarto, Brunswick, OH (US)

(21) Appl. No.: 16/279,540

(22) Filed: Feb. 19, 2019

Related U.S. Application Data
(60) Provisional application No. 62/632,744, filed on Feb. 20, 2018.
(60) Provisional application No. 62/663,676, filed on Apr. 27, 2018.

(51) Int. Cl. A01K 13/00; F25B 19/00

(52) U.S. Cl. CPC A01K 13/007; F25B 19/00

(57) ABSTRACT

A heating and/or cooling device such as a strap or blanket that can actively heat or cool the body of a domestic animal that is used to keep the domestic animal warm or cool, such as for increasing the production of milk in cold or hot weather, respectively

### CROSS-REFERENCE TO RELATED APPLICATIONS

This application claims the benefit of U.S. provisional application Ser. No. 62/632,744 filed on Feb. 20, 2018 and incorporated herein by reference. This application also claims the benefit of U.S. provisional application Ser. No. 62/663,676 filed on Apr. 27, 2018 and incorporated herein by reference.

### BACKGROUND OF THE INVENTION

Conventional approaches for cooling bovine such as dairy cows (and other farm animals) involve fans and spraying water with sprinkler systems for cooling the animals, and heaters for warming the animals. However, such methods are difficult to keep bovines cool over an extended period of time, and offer other drawbacks. The conventional methods offer temporary relief and do not help increase milk production.

Such methods are difficult to practice because it would be too labor intensive to spray cows with water throughout the entire day. An approach is needed to cool animals that is inexpensive and not labor intensive to cool dairy cows so as to increase milk production during heat stress compared to milk production decreasing during these extreme hot weather temperatures.

In addition, conventional approaches for warming bovine such as dairy cows or other animals involve keeping the wind off of the animals by providing good shelter, offering plenty of food and water for increased metabolism needs, and keeping cows dry and clean. Heaters may also be used. However, such methods are difficult to keep cows warm at all times and during milking. The conventional methods offer temporary relief, but do not help increase milk production. When cold stress is present due to extreme cold temperatures, then milk production drops.

A method is needed that is inexpensive and not labor intensive to warm dairy cows so as to increase milk production during cold stress, compared to milk production decreasing during these extreme cold weather temperatures.

### BRIEF SUMMARY OF THE INVENTION

Provided are a plurality of embodiments the invention, including, but not limited to: materials, size, and placement on the bovine that helps reduce the effects of heat stress.

Materials consist of cold or cooling material that stays cool for an extended period of time. The method involves selecting an appropriate the size of the cooling device that includes the optimal area for cooling down the bovine through a coolant halter or anklet device, and then placing the device on the animal.

The placement location involves implementing the invention around the ankles and the neck regions of the bovine, which are areas that help cool down the cow.

Further provided is a method of attaching coolant materials with specific size and placement location on the bovine. The steps are comprised of:

Securing the coolant material;

Cutting material to specific size;

Place coolant device on target locations on bovine;

Spray coolant device during milking engagements;

Coolant device is cool due to watering and keeps bovines cooled down.

Also provided are a plurality of embodiments the invention, including, but not limited to: materials, size, and placement on the bovine that helps reduce the effects of cold stress.

Materials comprising warming material that stays warm by using the animal's body heat for an extended period of time. The method involves the size of the invention that includes the optimal area for warming the bovine through a warming neck band or anklet device.

The placement location involves implementing the invention around the ankles and the neck regions of the bovine, which are areas that help warm the cow.

Further provided is a method of attaching warming materials with specific size and placement location on the bovine. The steps are comprised of:

Securing the warming material;

Cutting material to specific size;

Place warming device on target locations on bovine.

Also provided is a method of protecting domestic animals, comprising the steps of:
providing a plurality of cooling or heating devices configured to actively produce heat or absorb heat, respectively;
placing the cooling or heating devices around body parts of the animal;
activating the cooling or heating function of the devices, respectively; and
maintaining, on a regular basis, the cooling or heating functions of the devices upon depletion of the cooling or heating function of the devices.

Further provided is a method of protecting domestic animals, comprising the steps of:
providing a plurality of cooling devices configured to actively absorb heat through evaporation of water, wherein each one of said cooling devices is configured to encircle the neck or a leg of the animal;
placing each one of the cooling devices around the neck or a different leg of the animal;
activating the cooling devices by providing water for absorption by the cooling devices, respectively; and
maintaining, on a regular basis, the cooling devices by replenishing the water absorbed by the respective cooling devices.

Also provided is a method of protecting domestic animals, comprising the steps of:
providing a plurality of cooling devices configured to actively absorb heat through evaporation of water, wherein each one of said cooling devices is configured as a strap of material having a length substantially greater than a width;
encircling each leg of the animal with a respective at least one of said cooling devices;
activating the cooling devices by providing water for absorption by the cooling devices, respectively; and
maintaining, on a regular basis, the cooling devices by replenishing the water absorbed by the respective cooling devices by spraying the cooling devices with water.

Also provided are additional example embodiments, some, but not all of which, are described hereinbelow in more detail.

### BRIEF DESCRIPTION OF THE DRAWINGS

The features and advantages of the examples of the present invention described herein will become apparent to those that are dairy farmers to which the present invention relates upon reading the following description, with reference to the accompanying drawings, in which:

FIG. 1 is a perspective view of a schematic drawing of a first embodiment of the invention;

FIG. 2a is a front view of a schematic drawing of the first embodiment of the invention.

FIG. 2b is a back view of a schematic drawing of the first embodiment of the invention

FIG. 2c is an edge view of a schematic drawing showing laminate layers of a main strap of the first embodiment of the invention;

FIG. 3 is a top view of a schematic drawing of a second embodiment of the invention put into a working configuration for encircling the leg of an animal;

FIG. 4a is a photograph of a third embodiment of the invention shown in an open condition;

FIG. 4b is a photograph of the third embodiment of the invention shown in a working condition for encircling the leg of an animal;

FIG. 5 is a schematic of any embodiments of the invention shown encircling the leg of an animal;

FIG. 6a a photograph of a fourth embodiment of the invention shown in an open condition;

FIG. 6b is a photograph of the fourth embodiment of the invention shown in a working condition for encircling the neck of an animal;

FIG. 7 is a schematic of any embodiments of the invention shown encircling the neck of the animal; and

FIG. 8 is a schematic drawing of another embodiment of the invention configured for use on the thorax of an animal.

### DETAILED DESCRIPTION OF EXAMPLE EMBODIMENTS

Various embodiments of a cooling device positioned over areas of the bovine that are shown in the Figures are discussed, as are methods utilizing the device for implementing the invention in its various example embodiments. For example, a device with coolant for increasing milk production during heat stress, such as crushed ice, ice pack, (SAP) super absorbent polymers, gel polymerization, refrigerant gel, refrigerant liquid, ammonium nitrate, calcium ammonium nitrate, endothermic reaction gels, endothermic reaction liquid, or PVA (polyvinyl acetates) material.

Various embodiments of a warming device positioned over areas of the bovine are also discussed, as are methods utilizing the tool for implementing the invention. For example, a warming device for increasing milk production during cold stress, such as wool, animal skins, long underwear materials, synthetic materials, space blanket material, garbage bags, aluminum foil, aluminum fragments, thermal paper, ceramic fiber insulation, and thermal insulation are provided. Devices that use iron powder can also be provided.

Further provided are methods of implementing materials that fasten the cooling or heating materials, such as a halter, anklets, velcro, snaps, buttons, fabric glue, craft glue, space blankets, or aluminum foil. The cooling and/or warming devices could be washed and reused.

### First Example Embodiments: Cooling Devices

Example devices, such as one of the coolant devices disclosed herein, would typically be attached to the bovine by a fastener that is positioned on the bovine. The size of the coolant device depends on the placement on the bovine.

For example, a commercial product iCool PVA Towel by Frogg Toggs, as well as Dr. Cool Chill Sport Knit, Cold Snap Cooling Towel, Nlife Cooling Towel, Chill-Its, Arctic Blast, Way2Cool Mesh, O2cool Arctic Cloth, Kool Towel Chilly Pad, utilize a coolant material that is used for cooling athletes that could be modified for use as disclosed herein. These devices provide a cooling action by evaporative cooling.

In one embodiment the device may utilize microfiber cloth which exhibit a wicking function to absorb water and can typically retain water better than most cloths. These devices utilize the microfiber cloth that is washable, remains soft even as it dries.

Another embodiment utilizes Polyvinyl Acetate (PVA) cloth. These devices tend to retain more water than other cloths. However, they also tend to drip more than microfiber designs, yet less than cotton designs described below. PVA devices work well at cooling, but tend to retain smells and can dry stiff. It is more important to keep them continuously wet.

Still other embodiments can utilize cotton cloth. However, such devices tend to drip, need to be soaked more often, and are bulkier than the other options discussed herein.

Embodiments that utilize mesh microfiber cloth can also be used. These types of devices tend to be more lightweight than other cooling devices and subsequently are less bulky.

Still other embodiments may utilize any combination of the above materials.

These devices may be comprised of multiple layers of the cloth material, including the use of color structure is provided so that lighter surfaces can be provided to evaporate the water and stay cool. So long as they are kept moist, they will remove heat from any applied surfaces and hence cool the surfaces. Generally, such devices are reactivated after drying by soaking with water, wringing out excess water, and then providing a quick snap in the air.

Alternative approaches to providing a cooling device might utilize a chemical process to absorb heat. Many endothermic chemical reactions utilize waste heat for completing the reactions. Or sublimation processes might be used, such as by utilizing dry ice (solid carbon dioxide) to cool a device. The melting of various salts or other substances might also be utilized to absorb heat.

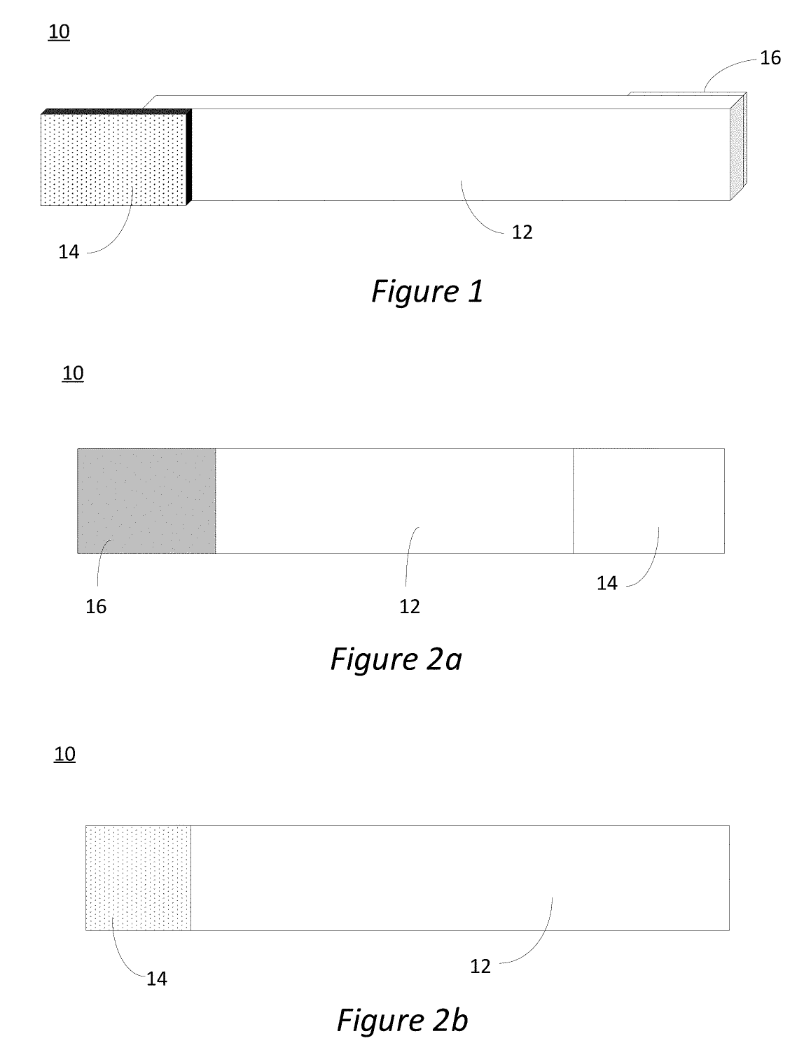

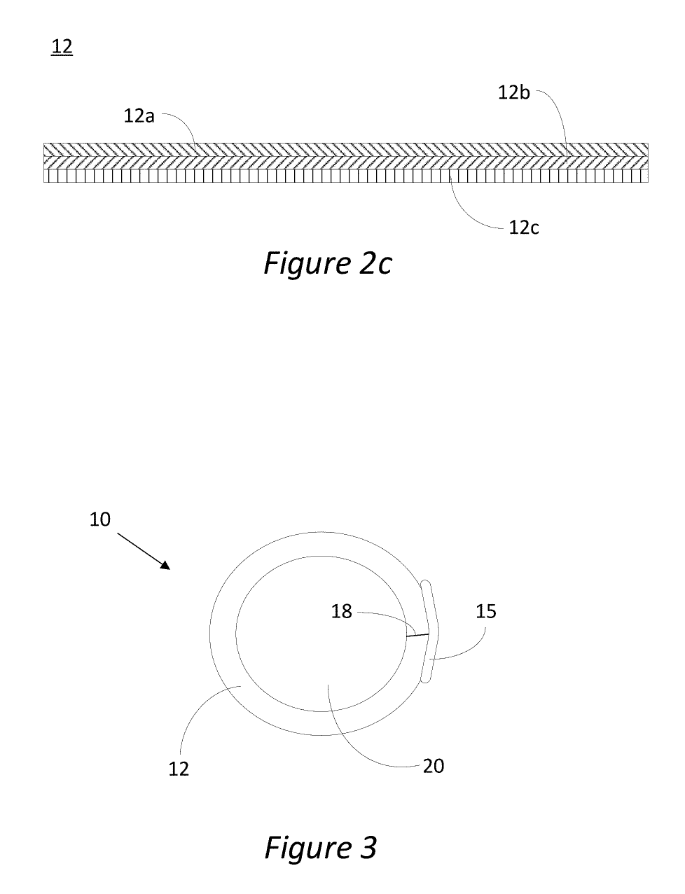

FIGS. 1, 2a, and 2b show various views of an example cooling strap 10 that is comprised of a main strap 12 that will include the cooling material, such as layers of the absorbent cloth discussed above, or some other cooling material. The strap 10 can be provided with hook 14, and loop 16 fasteners at ends of the main strap 12, such as by gluing the respective fastener portions to the main strap 12.

FIG. 2c shows an example structure of the main strap 12, having three layers 12a, 12b, and 12c laminated together, such as by gluing (e.g., using a fabric or other glue or adhesive) or stitching or spot welding, or riveting, or some other means of securing the laminated layers together. Any other number of layers could be utilized, from 1 to 2 or more. Each of these layers may be of the same material, such as any of those described above (e.g., microfiber or PVA cloth or meshes), or they may be of different materials to provide a hybrid structure all for absorbing water to provide evaporative cooling. Alternatively, the inner layer 12b might be provided with a chemical or some other substance such as a gel or other material used to provide the cooling process. Note that the strap 12 could be made elastic to allow the strap to have a more snug fit on the animal.

FIG. 3 shows another embodiment where the strap 10 is looped to form an inner void 20 with ends 18 being fastened using fastener 15, which may be a velcro fastener as discussed above, or a clip, or buckle, or some other means of fastening. The inner void 20 is used to receive the leg of an animal, for example, so that the strap 10 encircles the leg of the animal. Alternatively, one of the layers of the main strap 12 might be comprised of a metal strip that holds the strap in the desired shape, but allows it to be opened to be removed as well. The velcro straps secure the coolant device on the opposite end of the ankle straps. The velcro strap can be shortened or lengthened according to the size of the bovine's ankle region. The velcro strap might be made elastic for a more snug fit on the animal.

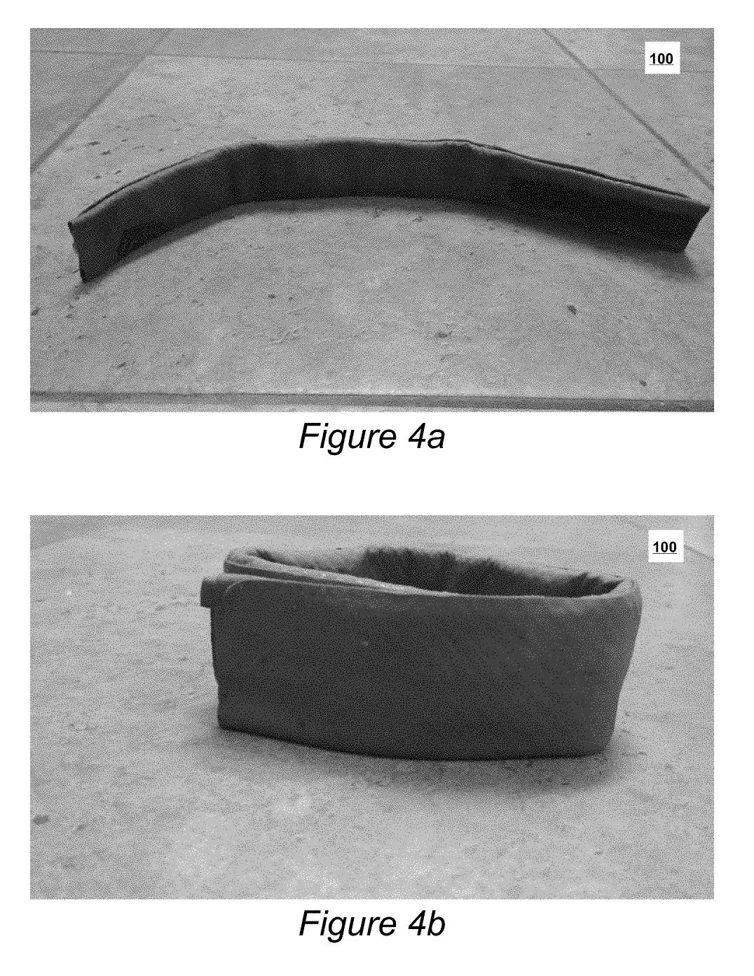

FIGS. 4a and 4b show examples of another embodiment having a strap 100 having a shape-holding function such as described in the above paragraph by using a flexible metal strip in the laminate. Alternative means of securing could be utilized as otherwise described herein.

The size (length and width) of the strap 10 is designed for use around a leg or tail of the animal, for example, or another relatively narrow body part. Hence, widths of a few inches and lengths of inches up to about a foot or so are anticipated.

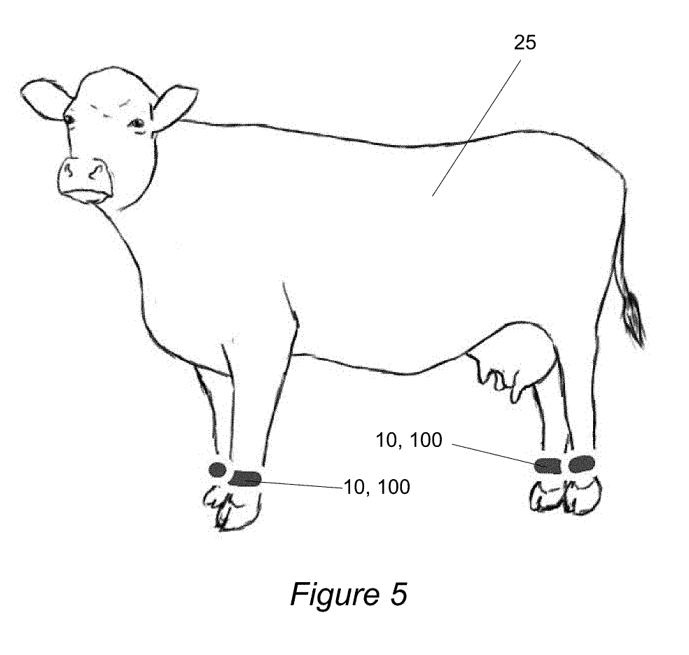

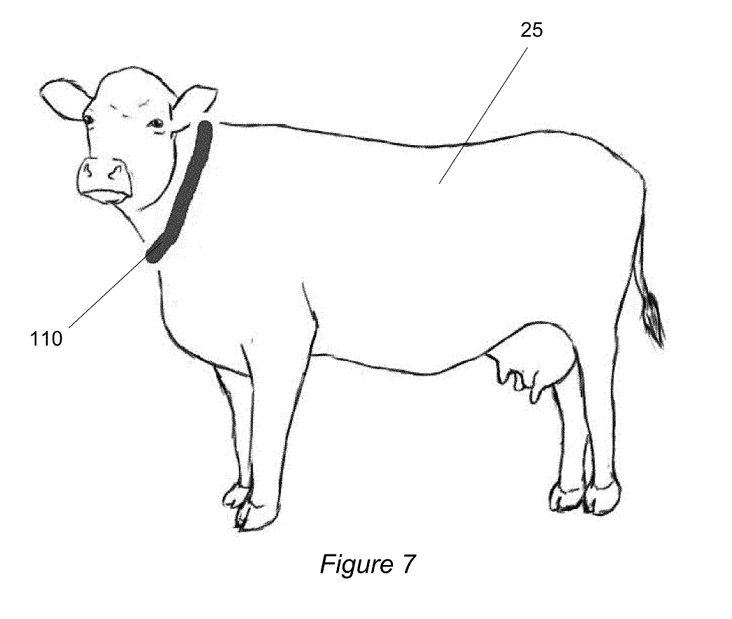

Generally, as shown in FIG. 5, the cooling process utilizes a plurality of straps 10, 100 such as discussed above. A farmer purchases a plurality of straps 10, 100 designed as ankle devices for use in encircling the legs of an animal, such as a cow, or goat, or horse, for example. For each animal 25, the farmer places a strap 10, 100 around each ankle of the animal, for a total of 4 straps 10, and may optionally or alternatively use a neck device 110 as shown in FIG. 7 and described below. For additional cooling, each leg might be provided with more than one strap 10, 100 at different locations along the legs.

The strap 10 is wrapped around the leg in a somewhat snug manner, with the ends fastened using the built in fastening feature (such as Velcro or snaps or other fastener as described herein). If a portion of the strap 10, such as part of velcro strap are made elastic, the fit can be made quite snug. Alternative means of fastening, such as the use of a buckle, or a clip, or a flexible metal strip, would be applied in the appropriate manner.

The cooling feature of the device is then activated, as necessary, to cool the animal. For one example embodiment using commercial products such as described above, the devices can be sprayed with water, or soaked in water in advance of application, activating the cooling function, which then cools the animal 25 in warm or hot weather. When the animal is a milk producer, the cooling leads to increased milk production. Every few hours, or every few days, the farmer will again spray the straps 10, 100 to keep them moist (or remove them, soak them, and reapply them), continuing the cooling operation. When cooling the body temperature of the cow is no longer desired, such as during cooler weather, the straps 10, 100 can be removed and cleaned and stored for later use.

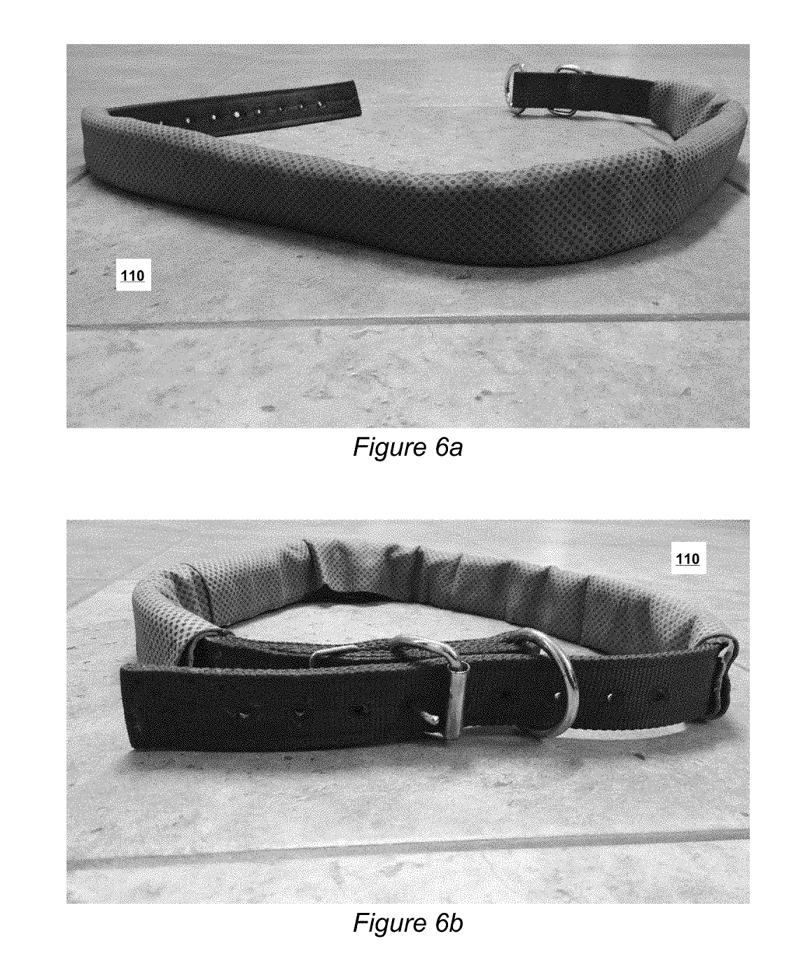

FIGS. 6a and 6b show a longer strap 110 having an adjustable buckle provided on the strap. This strap is designed for a wider body part of the animal, such as a neck or the thorax of the animal, for example. FIG. 7 shows such a strap 110 in use on the body of the animal 25. This strap can be applied, treated, and activated in basically the same manner as described above regarding straps 10, 100.

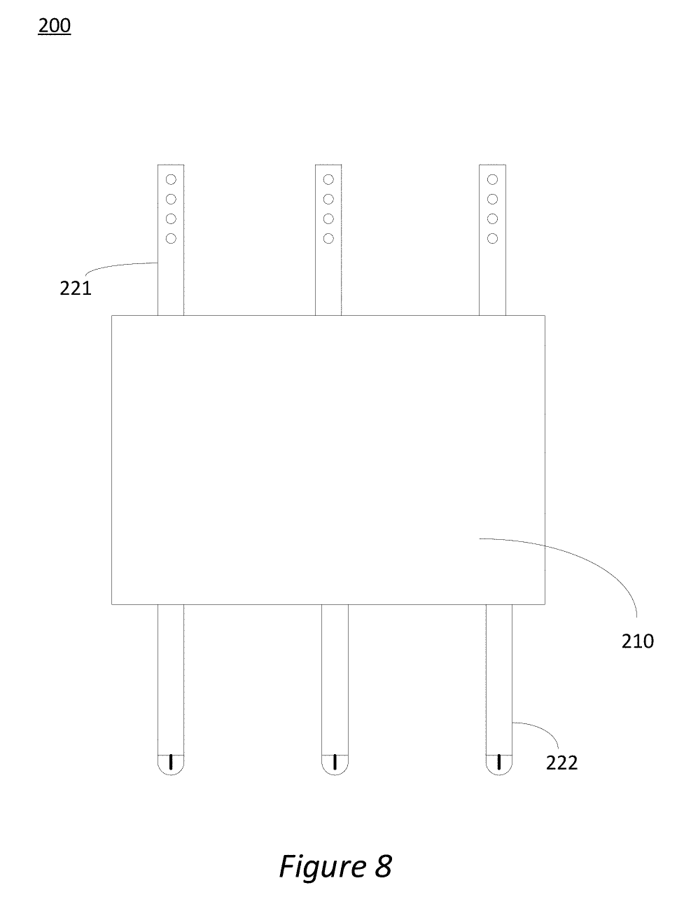

Alternative ways to use this coolant device include various sizes of halters and anklets, blankets, coats, legwarmers, head coverings, and/or scarves. For example, a shown in FIG. 8, a blanket device 200 could be provided that is hung over the back of the animal having a large main area 210 comprised of the cooling laminate (such as shown in FIG. 2c and described above), and secured using buckle straps 221, 222 that go under the body of the animal to be fastened underneath, or along a side. This device operates in a manner similar to the above described straps, but provides a much larger surface area for greater cooling during hotter weather, for example. Such a blanket device 200 could be provided of any size, and might cover a substantial, or minor, portion of the animal, such as the back, and/or sides and/or rear end of the animal.

In use, example cooling devices disclosed herein are provided as example embodiments of cooling devices. Such cooling devices can be attached as described above, such as by using velcro, such as a 2 in×8 in inch anklet, for example. Alternatively, the coolant device is attached with buttons, snaps, belt loops, straps, or other attachment mechanisms.

### Second Example Embodiments: Warming Devices

Alternative devices, such as warming devices disclosed herein, can also be provided. Such devices would typically be attached to the bovine by a fastener that is positioned on the animal, in a manner similar to that discussed above for the cooling devices. The size of the warming device depends on the placement on the animal, and can be provided of similar sizes as discussed above for the cooling devices.

For example, a commercial product Thermo TEC, as well as, The Original Space All Weather Blanket, Ultimate Survival Technologies Emergency Blanket, Coghlan's Emergency Blanket, and the Ever Ready Space Blanket are warming materials that are used for warming subjects that could be modified for use as disclosed herein to form straps and/or blankets. Customized devices of similar or different materials could also be produced. Alternatives might use devices that generate the heat chemically by an exothermic reaction, such as by the oxidation of iron, for example, or that store heat from another source, such as microwave ovens or heat sources. Heat packs using gels are available for keeping things warm, and hence the inner layer of the straps could be provided with such a heat-storing gel that might be recharged using microwaves, for example. Electrically generated heat using heating elements and batteries might also be used as an alternative.

The structure of the devices can be similar to those described above for the cooling devices, but replacing the materials with those described in this section or other heating materials, and hence those structures described above will not be repeated here.

The process of use is similar to that described above for the cooling devices. For example, a farmer purchases a plurality of ankle (and/or neck and/or blanket) devices. For each animal, the farmer places a device on each ankle of the animal, for a total of 4 devices, and may optionally or alternatively use a neck or body (blanket) device. The device is wrapped around the neck/ankle/body in a somewhat snug manner as described above, with the ends fastened using the built in fastening feature (such as, for example, Velcro, snaps, zippers, or tied with yarn). The devices are then activated by the body heat of the cow, or through chemical reaction or by releasing stored heat, which then warms the animal in cold weather, leading, for example, to increased milk production. When warming the animal is no longer desired, such as during the spring or summer months, then the devices can be cleaned, dried, and stored for later use.

Alternative ways to use the warming and/or cooling devices include various sizes of halters and anklets, blankets, coats, legwarmers, head coverings, scarves, as described above. Some embodiments of the devices might be disposable, such as those that use chemical reactions, or they might be refillable by replacing the chemicals or other heat/cool producing ingredients.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of protecting domestic animals, comprising the steps of:
providing a plurality of cooling or heating devices configured to actively produce heat or absorb heat, respectively;
placing the cooling or heating devices around body parts of the animal;
activating the cooling or heating function of the devices, respectively; and
maintaining, on a regular basis, the cooling or heating functions of the devices upon depletion of the cooling or heating function of the devices.

2. The method of claim 1, wherein the cooling or heating devices are cooling devices that absorb water, and that are configured to cool an applied surface by evaporation of the water from the device.

3. The method of claim 2, wherein the cooling devices are comprised of microfiber and/or PVA materials.

4. The method of claim 2, wherein the cooling devices are maintained by adding water to the cooling devices which is absorbed by the cooling devices.

5. The method of claim 1, wherein the cooling or heating devices are provided around a plurality of legs of the animal.

6. The method of claim 1, wherein the cooling or heating devices are provided around a neck of the animal.

7. The method of claim 1, wherein the cooling or heating devices are heating devices that provide warmth to the animal.

8. A method of protecting domestic animals, comprising the steps of:
providing a plurality of cooling devices configured to actively absorb heat through evaporation of water, wherein each one of said cooling devices is configured to encircle the neck or a leg of the animal;
placing each one of the cooling devices around the neck or a different leg of the animal;
activating the cooling devices by providing water for absorption by the cooling devices, respectively; and
maintaining, on a regular basis, the cooling devices by replenishing the water absorbed by the respective cooling devices.

9. The method of claim 8, wherein the cooling devices are comprised of microfiber and/or PVA materials.

10. The method of claim 8, wherein each leg of the animal is provided with at least one of the plurality of cooling devices encircling the respective leg.

11. The method of claim 10, wherein at least one of the cooling devices is provided around the neck of the animal.

12. The method of claim 8, wherein at least one of the cooling devices is provided around the neck of the animal.

13. The method of claim 8, wherein the water is replenished in the cooling devices by spraying each one of the cooling devices with water.

14. A method of protecting domestic animals, comprising the steps of:
providing a plurality of cooling devices configured to actively absorb heat through evaporation of water, wherein each one of said cooling devices is configured as a strap of material having a length substantially greater than a width;
encircling each leg of the animal with a respective at least one of said cooling devices;
activating the cooling devices by providing water for absorption by the cooling devices, respectively; and
maintaining, on a regular basis, the cooling devices by replenishing the water absorbed by the respective cooling devices by spraying the cooling devices with water.

15. The method of claim 14, wherein an additional cooling device is provided around the neck of the animal.

16. The method of claim 15, wherein the cooling devices are comprised of microfiber and/or PVA materials.

17. The method of claim 14, wherein the cooling devices are comprised of microfiber and/or PVA materials.

18. The method of claim 14, wherein an additional cooling device is provided as a blanket on a back of the animal.
